(19) United States
(12) Patent Application Publication
(10) Pub. No.: US 2018/0334470 A1
(43) Pub. Date: Nov. 22, 2018

(54) DIALKYL COBALT CATALYSTS AND THEIR USE FOR HYDROSILYLATION AND DEHYDROGENATIVE SILYLATION

(71) Applicants: Momentive Performance Materials Inc., Waterford, NY (US); PRINCETON UNIVERSITY, PRINCETON, NJ (US)

(72) Inventors: Tianning DIAO, New York, NY (US); Paul CHIRIK, Princeton, NJ (US); Aroop ROY, Mechanicville, NY (US); Johannes DELIS, Bergen op Zoom (NL); Kenrick LEWIS, Flushing, NY (US)

(21) Appl. No.: 16/047,084

(22) Filed: Jul. 27, 2018

Related U.S. Application Data
(62) Division of application No. 15/309,453, filed on Nov. 8, 2016.
(60) Provisional application No. 61/990,435, filed on May 8, 2014.

(51) Int. Cl. C07F 7/18; C07F 7/08; B01J 31/16; B01J 31/18

(52) U.S. Cl. CPC C07F 7/1876; B01J 2531/0244; B01J 2231/766; C07F 7/0829; Y02P 20/582; B01J 2531/845; B01J 2231/323; B01J 31/1815; B01J 31/1608

(57) ABSTRACT

Disclosed herein are dialkyl cobalt complexes containing pyridine di-imine ligands and their use as catalysts for hydrosilylation, dehydrogenative silylation, and/or crosslinking processes.

### CROSS-REFERENCE TO RELATED APPLICATIONS

The present application claims priority to and benefit of U.S. patent application Ser. No. 15/309,453 filed on Nov. 8, 2015, which claims priority to and the benefit of International Application No. PCT/US2015/029668, titled “DIALKYL COBALT CATALYSTS AND THEIR USE FOR HYDROSILYLATION AND DEHYDROGENATIVE SILYLATION” filed on May 7, 2015 which claims the benefit of U.S. Provisional Application Ser. No. 61/990,435 filed May 8, 2014, each of which is incorporated by reference herein in its entirety.

### FIELD OF THE INVENTION

This invention relates generally to transition metal-containing compounds, more specifically to dialkyl cobalt complexes containing pyridine di-imine ligands and their use as catalysts for hydrosilylation and dehydrogenative silylation reactions.

### BACKGROUND

Hydrosilylation chemistry, typically involving a reaction between a silyl hydride and an unsaturated organic group, is the basis for synthetic routes to produce commercial silicone-based products like silicone surfactants, silicone fluids and silanes as well as many addition cured products like sealants, adhesives, and coatings. Typical hydrosilylation reactions use precious metal catalysts to catalyze the addition of a silyl-hydride (Si—H) to an unsaturated group, such as an olefin. In these reactions, the resulting product is a silyl-substituted, saturated compound. In most of these cases, the addition of the silyl group proceeds in an anti-Markovnikov manner, i.e., to the less substituted carbon atom of the unsaturated group. Most precious metal catalyzed hydrosilylations only work well with terminally unsaturated olefins, as internal unsaturations are generally non-reactive or only poorly reactive. There are currently only limited commercially viable methods for the general hydrosilylation of olefins where after the addition of the Si—H group there still remains an unsaturation in the original substrate. This reaction, termed a dehydrogenative silylation, has potential uses in the synthesis of new silicone materials, such as silanes, silicone fluids, crosslinked silicone elastomers, and silylated or silicone-crosslinked organic polymers such as polyolefins, unsaturated polyesters, and the like.

Various precious metal complex catalysts are known in the art including a platinum complex containing unsaturated siloxanes as ligands, which is known in the art as Karstedt's catalyst. Other platinum-based hydrosilylation catalysts include Ashby's catalyst, Lamoreaux's catalyst, and Speier's catalyst.

Other metal-based catalysts have been explored including, for example, rhodium complexes, iridium complexes, palladium complexes and even first-row transition metal-based catalysts to promote limited hydrosilylations and dehydrogenative silylations.

U.S. Pat. No. 5,955,555 discloses the synthesis of certain iron or cobalt pyridine di-imine (PDI) dianion complexes. The preferred anions are chloride, bromide, and tetrafluoroborate. U.S. Pat. No. 7,442,819 discloses iron and cobalt complexes of certain tricyclic ligands containing a “pyridine” ring substituted with two imino groups. U.S. Pat. Nos. 6,461,994, 6,657,026 and 7,148,304 disclose several catalyst systems containing certain transitional metal-PDI complexes. U.S. Pat. No. 7,053,020 discloses a catalyst system containing, inter alia, one or more bisarylimino pyridine iron or cobalt catalyst. Chink et al describe bisarylimino pyridine cobalt anion complexes (Inorg. Chem. 2010, 49, 6110 and JACS. 2010, 132, 1676.) However, the catalysts and catalyst systems disclosed in these references are described for use in the context of olefin hydrogenation, polymerizations and/or oligomerisations, not in the context of dehydrogenative silylation reactions. U.S. Pat. No. 8,236,915 discloses hydrosilylation using Mn, Fe, Co, and Ni catalysts containing pyridinediimine complexes. However, these catalysts are structurally different from the catalysts of the present invention.

There is a continuing need in the silylation industry for non-precious metal-based catalysts that are effective for efficiently and selectively catalyzing hydrosilylation and/or dehydrogenative silylations. Moreover, there is a need for catalysts that are versatile in catalyzing hydrosilylation or dehydrogenative silylation via simple alteration of substituents.

Further, many industrially important homogeneous metal catalysts suffer from the drawback that following consumption of the first charge of substrates, the catalytically active metal is lost to aggregation and agglomeration and its beneficial catalytic properties are substantially diminished via colloid formation or precipitation. This is a costly loss, especially for noble metals such as Pt. Heterogeneous catalysts are used to alleviate this problem but have limited use for polymers and also have lower activity than homogeneous counterparts. For example, the two primary homogeneous catalysts for hydrosilylation, Speier's and Karstedt's, often lose activity after catalyzing a charge of olefin and silyl- or siloxyhydride reaction. If a single charge of the homogeneous catalyst could be re-used for multiple charges of substrates, then catalyst and process cost advantages would be significant.

### SUMMARY

The present invention provides dialkyl cobalt complexes. More specifically, the invention provides dialkylcobalt pyridinediimine complexes substituted with alkyl or alkoxy groups on the imine nitrogen atoms. The cobalt complexes can be used as catalysts for hydrosilylation and/or dehydrogenative silylation processes.

In one aspect, the present invention provides a cobalt complex of the Formula (I):

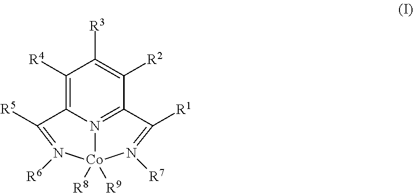

wherein each occurrence of R¹, R², R³, R⁴, and R⁵ is independently hydrogen, C1-C18 alkyl, a C1-C18 substituted alkyl, an aryl, a substituted aryl, or an inert substituent, wherein one or more of R¹—R⁵, other than hydrogen, optionally contain at least one heteroatom; each occurrence of R⁶ and R⁷ is independently a C1-C18 alkyl, a C1-C18 substituted alkyl, an alkoxy group, wherein one or both of R⁶ and R⁷ optionally contain at least one heteroatom; optionally any two of R¹—R⁷ vicinal to one another, R¹—R², and/or R⁴—R⁵ taken together may form a ring being a substituted or unsubstituted, saturated or unsaturated cyclic structure, with the proviso that R¹—R⁷ and R⁵—R⁶ are not taken to form a terpyridine ring; and R⁸ and R⁹ are independently chosen from a C1-C18 alkyl, a C1-C18 substituted alkyl groups, R⁸ and R⁹ optionally containing one or more heteroatoms.

In one embodiment, the cobalt complex is a complex of the Formula (II):

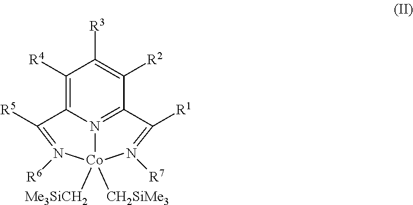

wherein R¹, R², R³, R⁴, R⁵, R⁶, and R⁷ can be as described above.

In another aspect, the present invention provides a process for producing a silylated product in the presence of the catalyst of Formula (I). In one embodiment, the process is a process for producing a hydrosilylated product. In another embodiment, the process is a process for producing a dehydrogenatively silylated product.

In one aspect, the present invention provides a process for the hydrosilylation of a composition, the process comprising contacting the composition comprising the hydrosilylation reactants with a complex of the Formula (I). In one embodiment, the hydrosilylation reactants comprise (a) an unsaturated compound containing at least one unsaturated functional group, (b) a silyl hydride or siloxyhydride containing at least one SiH functional group, and (c) a catalyst of Formula I or an adduct thereof, optionally in the presence of a solvent.

In one aspect, the present invention provides a process for producing a dehydrogenatively silylated product, the process comprising reacting a mixture comprising (a) an unsaturated compound containing at least one unsaturated functional group, (b) a silyl hydride or siloxyhydride containing at least one SiH functional group, and (c) a catalyst, optionally in the presence of a solvent, in order to produce the dehydrogenatively silylated product, wherein the catalyst is a complex of the Formula (I) or an adduct thereof.

### DETAILED DESCRIPTION

The invention relates to dialkylcobalt complexes containing pyridinediimine ligands and their use as efficient hydrosilylation catalysts and/or dehydrogenative silylation and catalysts. In one embodiment of the invention, there is provided a complex of the Formula (I), as illustrated above, wherein Co can be in any valence or oxidation state (e.g., +1, +2, or +3) for use in a hydrosilylation reaction, a dehydrogenative silylation reaction, and/or crosslinking reactions. In particular, according to one embodiment of the invention, a class of dialkylcobalt pyridine di-imine complexes has been found that are capable of hydrosilylation and/or dehydrogenative silylation reactions. It has now been unexpectedly discovered by the inventors that alkyl or alkoxy substitution on the imine nitrogens allows control over whether the catalysis affords hydrosilylated products and/or dehydrogenatively silylated products. This is in contrast to cobalt pyridine diimine complexes with aryl substitution on the imine nitrogens that exclusively produce dehydrogenatively silylated products such as described in U.S. application Ser. No. 13/966,568. The invention also addresses the advantage of reusing a single charge of catalyst for multiple batches of product, resulting in process efficiencies and lower costs.

As used herein, the term “alkyl” includes straight, branched, and/or cyclic alkyl groups. Specific and non-limiting examples of alkyls include, but are not limited to, methyl, ethyl, propyl, isobutyl, cyclopentyl, cyclohexyl, etc. Still other examples of alkyls include alkyls substituted with a heteroatom, including cyclic groups with a heteroatom in the ring.

As used herein, the term “substituted alkyl” includes an alkyl group that contains one or more substituent groups that are inert under the process conditions to which the compound containing these groups is subjected. The substituent groups also do not substantially or deleteriously interfere with the process. The alkyl and substituted alkyl groups can include one or more heteroatoms. In one embodiment, a substituted alkyl may comprise an alkylsilyl group. Examples of alkylsilyl groups include, but are not limited to alkylsilyl groups having 3-20 carbon atoms such as a trimethylsilyl group, a triethylsilyl group, a triisopropylsilyl group, etc. Optionally, the silyl moiety of the alkylsilyl group may also be represented by phenyldimethylsilyl, diphenylmethylsilyl, or triphenylsilyl.

As used herein, the term “alkoxy” refers to a monovalent group of the formula OR, where R is an alkyl group. Non-limiting examples of alkoxy groups include, for example, methoxy, ethoxy, propoxy, butoxy, benzyloxy, etc.

As used herein, the term “aryl” refers to a non-limiting group of any aromatic hydrocarbon from which one hydrogen atom has been removed. An aryl may have one or more aromatic rings, which may be fused, connected by single bonds or other groups. Examples of suitable aryls include, but are not limited to, tolyl, xylyl, phenyl, and naphthalenyl.

As used herein, the term “substituted aryl” refers to an aromatic group substituted as set forth in the above definition of “substituted alkyl.” Similar to an aryl, a substituted aryl may have one or more aromatic rings, which may be fused, connected by single bonds or other groups; however, when the substituted aryl has a heteroaromatic ring, the attachment can be through a heteroatom (such as nitrogen) of the heteroaromatic ring instead of a carbon. In one embodiment, the substituted aryl groups herein contain 1 to about 30 carbon atoms.

As used herein, the term “alkenyl” refers to any straight, branched, or cyclic alkenyl group containing one or more carbon-carbon double bonds, where the point of substitution can be either a carbon-carbon double bond or elsewhere in the group. Examples of suitable alkenyls include, but are not limited to, vinyl, propenyl, allyl, methallyl, ethylidenyl norbornyl, etc.

As used herein, the term “alkynyl” refers to any straight, branched, or cyclic alkynyl group containing one or more carbon-carbon triple bonds, where the point of substitution can be either at a carbon-carbon triple bond or elsewhere in the group.

As used herein, the term “unsaturated” refers to one or more double or triple bonds. In one embodiment, it refers to carbon-carbon double or triple bonds.

As used herein, the term “inert substituent” refers to a group other than hydrocarbyl or substituted hydrocarbyl, which is inert under the process conditions to which the compound containing the group is subjected. The inert substituents also do not substantially or deleteriously interfere with any process described herein that the compound in which they are present may take part in. Examples of inert substituents include, but are not limited to, halo (fluoro, chloro, bromo, and iodo), and ether such as —OR³⁰ wherein R³⁰ is hydrocarbyl or substituted hydrocarbyl.

As used herein, the term “hetero atoms” refers to any of the Group 13-17 elements except carbon, and can include, for example, oxygen, nitrogen, silicon, sulfur, phosphorus, fluorine, chlorine, bromine, and iodine.

As used herein, the term “olefin” refers to any aliphatic or aromatic hydrocarbon also containing one or more aliphatic carbon-carbon unsaturations. Such olefins may be linear, branched, or cyclic and may be substituted with heteroatoms as described above, with the proviso that the substituents do not interfere substantially or deleteriously with the course of the desired reaction to produce the dehydrogenatively silylated product.

### Cobalt Complexes

The present invention provides, in one aspect, a cobalt complex, which complex can be used as a catalyst in hydrosilylation or dehydrogenative silylation reactions. The catalyst composition comprises a dialkylcobalt complex containing a pyridine di-imine (PDI) ligand with alkyl or alkoxy substitution on the imine nitrogen atoms. In one embodiment, the catalyst is a complex of the Formula (I) or an adduct thereof:

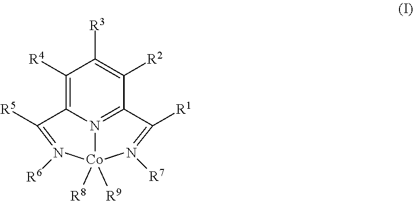

wherein each occurrence of R¹, R², R³, R⁴, and R⁵ is independently hydrogen, a C1-C18 alkyl, a C1-C18 substituted alkyl, an aryl, a substituted aryl, or an inert substituent, wherein one or more of R¹—R⁵, other than hydrogen, optionally contain at least one heteroatom; each occurrence of R⁶ and R⁷ is independently a C1-C18 alkyl, a C1-C18 substituted alkyl, or an alkoxy group, wherein one or both of R⁶ and R⁷ optionally contain at least one heteroatom; optionally any two of R¹—R⁷ vicinal to one another, R¹—R², and/or R⁴—R⁵ taken together may form a ring being a substituted or unsubstituted, saturated or unsaturated cyclic structure, with the proviso that R¹—R⁷ and R⁵—R⁶ are not taken to form a terpyridine ring; and R⁸ and R⁹ are independently chosen from a C1-C18 alkyl, or a C1-C18 substituted alkyl, R⁸ and R⁹ optionally containing one or more heteroatoms. In the catalyst complex Co can be in any valence or oxidation state (e.g., +1, +2, or +3).

In one embodiment both R⁶ and R⁷ are independently alkyl or alkoxy groups, linear, branched or cyclic, substituted or unsubstituted and optionally containing one or more heteroatoms. In one embodiment, R⁶ and R⁷ are independently chosen from methyl, ethyl, and methoxy.

In one embodiment, the cobalt complex is such that R⁶ and R⁷ are a methyl or methoxy group; R¹ and R⁵ are independently methyl or phenyl groups; and R², R³ and R⁴ may be hydrogen. In one embodiment, at least one of R², R³, and/or R⁴ is chosen from an alkyl group substituted with a heteroatom. In one embodiment, the alkyl group comprises a nitrogen-containing cyclic group. In one embodiment, the nitrogen-containing cyclic group is a pyrrolidinyl group.

In one embodiment, R⁸ and R⁹ are independently chosen from a C1-C10 alkyl or substituted alkyl, optionally containing one or more hetero atoms. In one embodiment, R⁸ and R⁹ are independently chosen from an alkyl silyl group. In one embodiment, the cobalt complex is of the Formula (II). In one embodiment, R⁸ and R⁹ are each trimethylsilylmethyl.

Non-limiting examples of suitable cobalt complexes include complexes of the Formulas (III)-(VI):

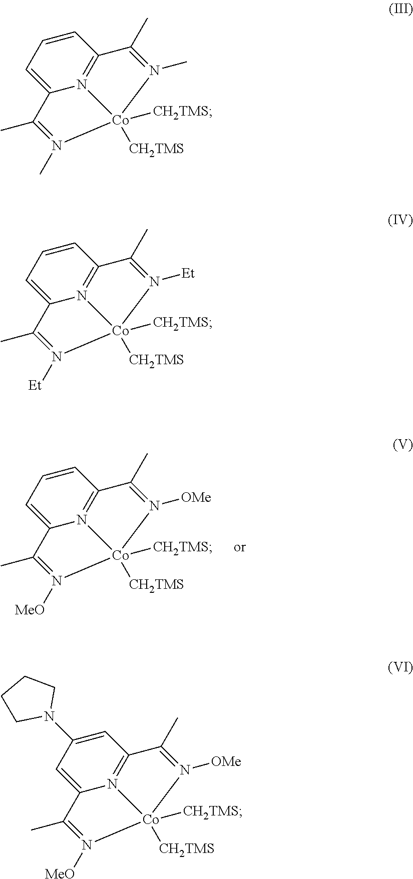

where TMS is trimethylsilyl and Ns is trimethylsilylmethyl.

In the reaction processes of the invention, the catalysts can be unsupported or immobilized on a support material, for example, carbon, silica, alumina, MgCl₂ or zirconia, or on a polymer or prepolymer, for example polyethylene, polypropylene, polystyrene, poly(aminostyrene), or sulfonated polystyrene. The metal complexes can also be supported on dendrimers.

In some embodiments, for the purposes of attaching the metal complexes of the invention to a support, it is desirable that at least one of R¹ to R⁷ of the metal complexes has a functional group that is effective to covalently bond to the support. Exemplary functional groups include, but are not limited to, vinyl, SH, COOH, NH₂, or OH groups.

### Catalyzed Reactions

In accordance with the present invention, the cobalt complexes of Formula (I) can be used as a catalyst for a dehydrogenative silylation process, hydrosilylation reaction process, and/or a cross-linking reaction process. The dehydrogenative silylation and hydrosilylation processes generally comprise reacting a silyl hydride compound with an unsaturated compound having at least one unsaturated functional group.

The silyl hydride employed in the reactions is not particularly limited. It can be, for example, any compound chosen from hydrosilanes or hydrosiloxanes including those compounds of the formulas R¹⁰ₘSiHₚX₄₋₍ₘ₊ₚ₎ or MₐM^{H}_{b}D_{c}D^{H}_{d}TₑT^{H}_{f}Q_{g}, where each R¹⁰ is independently a substituted or unsubstituted aliphatic or aromatic hydrocarbyl group, X is alkoxy, acyloxy, or silazane, m is 1-3, p is 1-3, and M, D, T, and Q have their usual meaning in siloxane nomenclature. The subscripts a, b, c, d, e, f, and g are such that the molar mass of the siloxane-type reactant is between 100 and 100,000 Dalton. In one embodiment, an “M” group represents a monofunctional group of formula R¹¹₃SiO_{1/2}, a “D” group represents a difunctional group of formula R¹²₂SiO_{2/2}, a “T” group represents a trifunctional group of formula R¹³SiO_{3/2}, and a “Q” group represents a tetrafunctional group of formula SiO_{4/2}, an “M^{H}” group represents HR¹⁴₂SiO_{1/2}, a “T^{H}” represents HSiO_{3/2}, and a “D^{H}” group represents R¹⁵HSiO_{2/2}. Each occurrence of R¹¹ is independently C1-C18 alkyl, C1-C18 substituted alkyl, C6-C14 aryl or substituted aryl, wherein R¹¹ optionally contains at least one heteroatom.

The instant invention also provides hydrosilylation and dehydrogenative silylation with hydridosiloxanes comprising carbosiloxane linkages (for example, Si—CH₂—Si—O—SiH, Si—CH₂—CH₂—Si—O—SiH or Si-arylene-Si—O—SiH). Carbosiloxanes contain both the —Si-(hydrocarbylene)-Si— and Si—O—Si— functionalities, where hydrocarbylene represents a substituted or unsubstituted, divalent alkylene, cycloalkylene or arylene group. The synthesis of carbosiloxanes is disclosed in U.S. Pat. No. 7,259,220; U.S. Pat. Nos. 7,326,761 and 7,507,775 all of which are incorporated herein in their entirety by reference. An exemplary formula for hydridosiloxanes with carbosiloxane linkages is RⁱRⁱⁱRⁱⁱⁱSi(CH₂R^{iv})ₓSiOSiR^{v}R^{vi}(OSiR^{vii}R^{viii})_{y}OSiR^{ix}R^{x}H, wherein Rⁱ—R^{x} is independently a monovalent alkyl, cycloalkyl or aryl group such as methyl, ethyl, cyclohexyl or phenyl. Additionally, Rⁱ independently may also be H. The subscript x has a value of 1-8, y has a value from zero to 10 and is preferably zero to 4. A specific example of a hydridocarbosiloxane is (CH₃)₃SiCH₂CH₂SiOSi(CH₃)₂H.

A variety of reactors can be used in the process of this invention. Selection is determined by factors such as the volatility of the reagents and products. Continuously stirred batch reactors are conveniently used when the reagents are liquid at ambient and reaction temperature. These reactors can also be operated with a continuous input of reagents and continuous withdrawal of dehydrogenatively silylated or hydrosilylated reaction product. With gaseous or volatile olefins and silanes, fluidized-bed reactors, fixed-bed reactors and autoclave reactors can be more appropriate.

The unsaturated compound containing at least one unsaturated functional group employed in the hydrosilylation reaction is generally not limited and can be chosen from an unsaturated compound as desired for a particular purpose or intended application. The unsaturated compound can be a mono-unsaturated compound or it can comprise two or more unsaturated functional groups. In one embodiment, the unsaturated group can be an aliphatically unsaturated functional group. Examples of suitable compounds containing an unsaturated group include, but are not limited to, unsaturated polyethers such as alkyl-capped allyl polyethers, vinyl functionalized alkyl capped allyl or methylallyl polyethers; terminally unsaturated amines; alkynes; C2-C45 olefins, in one embodiment alpha olefins; unsaturated epoxides such as allyl glycidyl ether and vinyl cyclohexene-oxide; terminally unsaturated acrylates or methyl acrylates;

unsaturated aryl ethers; unsaturated aromatic hydrocarbons; unsaturated cycloalkanes such as trivinyl cyclohexane; vinyl-functionalized polymer or oligomer; vinyl-functionalized and/or terminally unsaturated allyl-functionalized silane and/or vinyl-functionalized silicones; unsaturated fatty acids; unsaturated fatty esters; or combinations of two or more thereof. Illustrative examples of such unsaturated substrates include, but are not limited to, ethylene, propylene, isobutylene, 1-hexene, 1-octene, 1-octadecene, styrene, alpha-methylstyrene, cyclopentene, norbornene, 1,5-hexadiene, norbornadiene, vinylcyclohexene, allyl alcohol, allyl-terminated polyethyleneglycol, allylacrylate, allyl methacrylate, allyl glycidyl ether, allyl-terminated isocyanate-or acrylate prepolymers, polybutadiene, allylamine, methallyl amine, methyl(undecanoate), acetylene, phenylacetylene, vinyl-pendent or vinyl-terminal polysiloxanes, vinylcyclosiloxanes, vinylsiloxane resins, other terminally-unsaturated alkenyl silanes or siloxanes, vinyl-functional synthetic or natural minerals, etc.

Unsaturated polyethers suitable for the hydrosilylation reaction include polyoxyalkylenes having the general formula:

R¹⁶(OCH₂CH₂)_{z}(OCH₂CHR¹⁷)_{w}—OR¹⁸; and/or

R¹⁶O(CHR¹⁷CH₂O)_{w}(CH₂CH₂O)_{z}—CR¹⁹₂—C≡C—CR¹⁹₂(OCH₂CH₂)_{z}(OCH₂CHR¹⁷)_{w}OR¹⁸ wherein R¹⁶ denotes an unsaturated organic group containing from 2 to 10 carbon atoms such as allyl, methylallyl, propargyl or 3-pentynyl. When the unsaturation is olefinic, it is desirably terminal to facilitate smooth hydrosilylation. However, when the unsaturation is a triple bond, it may be internal. R¹⁸ is independently hydrogen, vinyl, allyl, methallyl, or a polyether capping group of from 1 to 8 carbon atoms such as the alkyl groups: CH₃, n-C₄H₉, t-C₄H₉ or i-C₈H₁₇, the acyl groups such as CH₃COO, t-C₄H₉COO, the beta-ketoester group such as CH₃C(O)CH₂C(O)O, or a trialkylsilyl group. R¹⁷ and R¹⁹ are monovalent hydrocarbon groups such as the C1-C20 alkyl groups, for example, methyl, ethyl, isopropyl, 2-ethylhexyl, dodecyl and stearyl, or the aryl groups, for example, phenyl and naphthyl, or the alkaryl groups, for example, benzyl, phenylethyl and nonylphenyl, or the cycloalkyl groups, for example, cyclohexyl and cyclooctyl. R¹⁹ may also be hydrogen. Methyl is particularly suitable for the R¹⁷ and R¹⁹ groups. Each occurrence of z is 0 to 100 inclusive and each occurrence of w is 0 to 100 inclusive. In one embodiment, the values of z and w are 1 to 50 inclusive.

As indicated above, the present invention is directed, in one embodiment, to a process for producing a dehydrogenatively silylated product comprising reacting a mixture comprising (a) an unsaturated compound containing at least one unsaturated functional group, (b) a silyl hydride and/or siloxyhydride containing at least one SiH functional group, and (c) a catalyst, optionally in the presence of a solvent, in order to produce the dehydrogenatively silylated product, wherein the catalyst is a complex of the Formula (I) or an adduct thereof. In one embodiment, the process includes contacting the composition with a metal complex of the catalyst, either supported or unsupported, to cause the silyl/siloxy hydride to react with the compound having at least one unsaturated group to produce a dehydrogenative silylation product, which may contain the metal complex catalyst. The dehydrogenative silylation reaction can be conducted optionally in the presence of a solvent. If desired, when the dehydrogenative silylation reaction is completed, the metal complex can be removed from the reaction product by magnetic separation and/or filtration. These reactions may be performed neat or diluted in an appropriate solvent. Typical solvents include benzene, toluene, diethyl ether, etc. In one embodiment, the reaction is performed under an inert atmosphere.

Effective catalyst usage for dehydrogenative silylation ranges from 0.001 mole percent to 5 mole percent based on the molar quantity of the alkene to be reacted. Preferred levels are from 0.005 to 1 mole percent. The reaction may be run at temperatures from about −10° C. up to 300° C., depending on the thermal stability of the alkene, silyl hydride and the specific pyridine di-imine complex. Temperatures in the range, 10-100° C., have been found to be effective for most reactions. Heating of reaction mixtures can be done using conventional methods as well as with microwave devices.

The dehydrogenative silylation reactions of this invention can be run at subatmospheric and supra-atmospheric pressures. Typically, pressures from about 1 atmosphere (0.1 MPa) to about 200 atmospheres (20 MPa), preferably to about 50 atmospheres (5.0 MPa), are suitable. Higher pressures are effective with volatile and/or less reactive alkenes which require confinement to enable high conversions.

The catalysts of the invention are useful for catalyzing dehydrogenative silylation reactions. For example, when an appropriate silyl hydride, such as triethoxy silane, triethyl silane, MD^{H}M, or a silyl-hydride functional polysiloxane (Silforce® SL 6020 D1 from Momentive Performance Materials, Inc., for example), are reacted with a mono-unsaturated hydrocarbon, such as octene, dodecene, butene, etc, in the presence of the Co catalyst, the resulting product is a terminally-silyl-substituted alkene, where the unsaturation is in a beta position relative to the silyl group. A by-product of this reaction is the hydrogenated olefin. When the reaction is performed with a molar ratio of silane to olefin of 0.5:1 (a 2:1 molar ratio of olefin to silane) the resulting products are formed in a 1:1 ratio.

The reactions are typically facile at ambient temperatures and pressures, but can also be run at lower or higher temperatures (−10 to 300° C.) or pressures (ambient to 205 atmospheres, (0.1-20.5 MPa)). A range of unsaturated compounds can be used in this reaction, such as N,N-dimethylallyl amine, allyloxy-substituted polyethers, cyclohexene, and linear alpha olefins (i.e., 1-butene, 1-octene, 1-dodecene, etc.). When an alkene containing internal double bonds is used, the catalyst is capable of first isomerizing the olefin, with the resulting reaction product being the same as when the terminally-unsaturated alkene is used.

Because the double bond of an alkene is preserved during the dehydrogenative silylation reaction employing these cobalt catalysts, a singly-unsaturated olefin may be used to crosslink silyl-hydride containing polymers. For example, a silyl-hydride polysiloxane, such as Silforce® SL6020 D1 (MD₁₅D^{H}₃₀M), may be reacted with 1-octene in the presence of the cobalt catalysts of this invention to produce a crosslinked, elastomeric material. A variety of new materials can be produced by this method by varying the hydride polymer and length of the olefin used for the crosslinking. Accordingly, the catalysts used in the process of the invention have utility in the preparation of useful silicone products, including, but not limited to, coatings, for example, release coatings, room temperature vulcanizates, sealants, adhesives, products for agricultural and personal care applications, and silicone surfactants for stabilizing polyurethane foams.

Furthermore, the dehydrogenative silylation may be carried out on any of a number of unsaturated polyolefins, such as polybutadiene, polyisoprene or EPDM-type copolymers, to either functionalize these commercially important polymers with silyl groups or crosslink them via the use of hydrosiloxanes containing multiple SiH groups at lower temperatures than conventionally used. This offers the potential to extend the application of these already valuable materials in newer commercially useful areas.

The catalyst complexes of the invention are efficient and selective in catalyzing dehydrogenative silylation reactions. For example, when the catalyst complexes of the invention are employed in the dehydrogenative silylation of an alkyl-capped allyl polyether or a compound containing an unsaturated group, the reaction products are essentially free of unreacted alkyl-capped allyl polyether and its isomerization products or unreacted compound with the unsaturated group. Further, when the compound containing an unsaturated group is an unsaturated amine compound, the dehydrogenatively silylated product is essentially free of internal addition products and isomerization products of the unsaturated compound. In one embodiment, where the unsaturated starting material is an olefin, the reaction is highly selective for the dehydrogenative silylated product, and the reaction products are essentially free of any alkene by-products. As used herein, “essentially free” is meant no more than 10 wt. %, preferably 5 wt. % based on the total weight of the dehydrogenative silylation product. “Essentially free of internal addition products” is meant that silicon is added to the terminal carbon.

The cobalt complexes can also be used as a catalyst for the hydrosilylation of a composition containing a silyl hydride and a compound having at least one unsaturated group.

The hydrosilylation process includes contacting the composition with a cobalt complex of the Formula (I), either supported or unsupported, to cause the silyl hydride to react with the compound having at least one aliphatically unsaturated group to produce a hydrosilylation product. The hydrosilylation product may contain the components from the catalyst composition. The hydrosilylation reaction can be conducted optionally in the presence of a solvent, at subatmospheric or supra-atmospheric pressures and in batch or continuous processes. The hydrosilylation reaction can be conducted at temperatures of from about −10° C. to about 200° C. If desired, when the hydrosilylation reaction is completed, the catalyst composition can be removed from the reaction product by filtration. The hydrosilylation can be conducted by reacting one mole of the same type silyl hydride with one mole of the same type of unsaturated compound as for the dehydrogenative silylation.

As described above, the catalyst can comprise a cobalt complex of Formula (I). In one embodiment, for a hydrosilylation process, the cobalt complex is such that R⁶ and/or R⁷ in Formula (I) are an alkyl group. In one embodiment, R⁶ and R⁷ are methyl. In one embodiment, the hydrosilylation process can employ a cobalt complex of Formulas (II), (III), (IV), (V), (VI), or a combination of two or more thereof. Changing the R⁶ and R⁷ groups may allow for control of the silylated products obtained from the reaction. For example, having R⁶ and R⁷ as methyl groups may favor formation of hydrosilylated products, while higher alkyl groups or alkoxy groups at R⁶ and R⁷ can yield both hydrosilylated and dehydrogenatively silylated products.

The cobalt complexes of the invention are efficient and selective in catalyzing hydrosilylation reactions. For example, when the metal complexes of the invention are employed in the hydrosilylation of an alkyl-capped allyl polyether and a compound containing an unsaturated group, the reaction products are essentially free of unreacted alkyl-capped allyl polyether and its isomerization products. In one embodiment, the reaction products do not contain the unreacted alkyl-capped allyl polyether and its isomerization products. In one embodiment, the hydrosilylation process can produce some dehydrogenative silylated products. The hydrosilylation process, however, can be highly selective for the hydrosilylated product, and the products are essentially free of the dehydrogenative product. As used herein, “essentially free” is meant no more than 10 wt. %, no more than 5 wt. %, no more than 3 wt. %; even no more than 1 wt. % based on the total weight of the hydrosilylation product. “Essentially free of internal addition products” is meant that silicon is added to the terminal carbon.

The catalyst composition can be provided for either the dehydrogenative silylation or hydrosilylation reactions in an amount sufficient to provide a desired metal concentration. In one embodiment, the concentration of the catalyst is about 5% (50000 ppm) or less based on the total weight of the reaction mixture; about 1% (10000 ppm) or less; 5000 ppm or less based on the total weight of the reaction mixture; about 1000 ppm or less; about 500 ppm or less based on the total weight of the reaction mixture; about 100 ppm or less; about 50 ppm or less based on the total weight of the reaction mixture; even about 10 ppm or less based on the total weight of the reaction mixture. In one embodiment, the concentration of the catalyst is from about 10 ppm to about 50000 ppm; about 100 ppm to about 10000 ppm; about 250 ppm to about 5000 ppm; even about 500 ppm to about 2500 ppm. In one embodiment, the concentration of the metal atom is from about 100 to about 1000 ppm based on the total weight of the reaction mixture. The concentration of the metal (e.g., cobalt) can be from about 1 ppm to about 5000 ppm; from about 5 ppm to about 2500 ppm; from about 10 ppm to about 1000 ppm, even from about 25 ppm to about 500 ppm. Here as elsewhere in the specification and claims, numerical values can be combined to form new and non-disclosed ranges.

The following examples are intended to illustrate, but in no way limit the scope of the present invention. All parts and percentages are by weight and all temperatures are in Celsius unless explicitly stated otherwise. All the publications and the US patents referred to in the application are hereby incorporated by reference in their entireties.

### Examples

### General Considerations

All air- and moisture-sensitive manipulations were carried out using standard Schlenk techniques or in an MBraun inert atmosphere dry box containing an atmosphere of purified nitrogen. Solvents for air- and moisture-sensitive manipulations were dried and deoxygenated by passing through solvent system columns and stored with 4 Å molecular sieves in the dry box. Benzene-d₆ was purchased from Cambridge Isotope Laboratories, dried over sodium and stored with 4 Å molecular sieves in the dry box. Substrates were dried over LiAlH₄ or CaH₂ and degased under high vacuum before use.

NMR spectra were acquired on a Varian INOVA-500 or Bruker-500 MHz spectrometer. The chemical shifts (δ) of ¹H NMR spectra are given in parts per million and referenced to the residual H-signal of benzene-d₆ (7.16 ppm) or chloroform-d (7.24 ppm).

### Synthesis of ^{Me}APDI Ligand

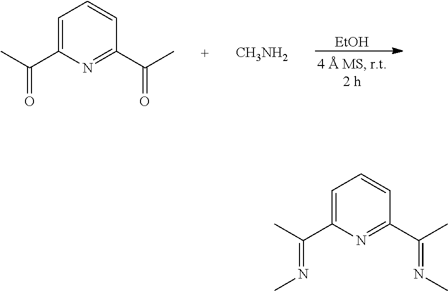

Diacetylpyridine (4 g, 24.5 mmol) was weighed into a thick walled glass vessel followed by addition of activated 4 Å molecular sieves (6 g). A solution of CH₃NH₂ in EtOH (29 mL, 33 wt %, 10 equiv) was injected into the flask. The thick walled glass vessel was immediately sealed and stirred at room temperature for 2 h. To the resulting mixture was added CH₂Cl₂, followed by filtration. The solid was washed with more CH₂Cl₂. The solvent from the filtrate was removed under vacuum to afford an off-white solid, determined as the desired product in 99% yield. The product is suitable for complexation with no purification. A colorless solid in 90% yield can be obtained via recrystallization from Et₂O. ¹H NMR (500 MHz, Benzene-d₆) δ 8.37 (d, J=7.8 Hz, 2H), 7.21 (t, J=7.8 Hz, 1H), 3.30 (s, 6H), 2.22 (s, 6H). ¹³C NMR (126 MHz, C₆D₆) δ 167.57, 156.44, 136.48, 121.24, 39.67, 12.80.

### Synthesis of ^{Et}APDI Ligand

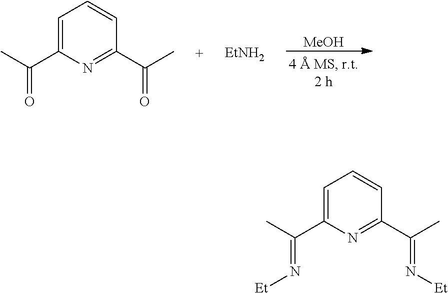 [SMILES: "MeOH" ; "EtNH2" ; CC(=O)c1cccc(C(C)=O)n1 ; CC/N=C(\C)c1cccc(/C(C)=N/CC)n1]

Diacetylpyridine (2 g, 12.2 mmol) was weighed into a thick walled glass vessel followed by addition of activated 4A molecular sieves (2 g). A solution of EtNH₂ in MeOH (37 mL, 2.0 M, 6 equiv) was injected into the flask. The thick walled glass vessel was immediately sealed and the reaction mixture stirred at room temperature for 2 hours. To the resulting mixture was added CH₂Cl₂, followed by filtration. The solid was washed with more CH₂Cl₂. The solvent from the filtrate was removed under vacuum to afford a yellow solid, determined as the desired product in 90% yield. The ligand turns brown when stored for an extended time, but is still suitable for complexation with cobalt. ¹H NMR (400 MHz, Chloroform-d) δ 8.06 (dd, J=7.8, 0.8 Hz, 2H), 7.74-7.66 (m, 1H), 3.80-3.43 (m, 4H), 2.40 (q, J=0.9 Hz, 6H), 1.34 (td, J=7.3, 0.8 Hz, 6H).

### Synthesis of ^{MeO}APDI Ligand

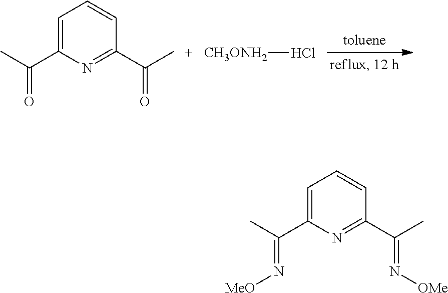

Diacetylpyridine (3 g, 18.4 mmol) and CH₃ONH₂-HCl (3.1 g, 36.8 mmol, 2 equiv) were weighed into a round bottom flask. The mixture was refluxed in toluene for 12 hours. Toluene was removed under vacuum to yield an off-white solid in 95% yield. The crude product was recrystallized from Et₂O to afford a crystalline white solid in 85% yield. ¹H NMR (500 MHz, Benzene-d₆) δ 7.93 (d, J=7.8 Hz, 2H), 7.06 (t, J=7.8 Hz, 1H), 3.87 (s, 6H), 2.43 (s, 6H). ¹³C NMR (126 MHz, C₆D₆) δ 155.82, 153.60, 136.16, 120.19, 62.13, 10.92.

Synthesis of ^{p-pyrrolidinyl,Me}APDI Ligand

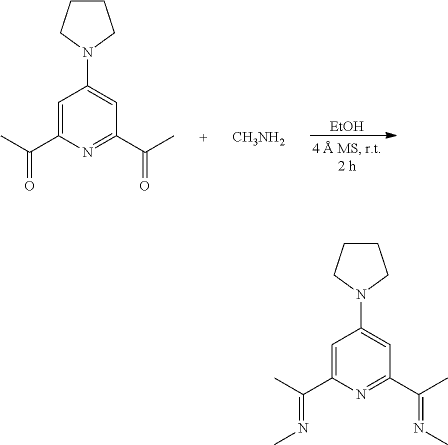 [SMILES: "EtOH" ; CC(=O)c1cc(N2CCCC2)cc(C(C)=O)n1 ; "CH3NH2" ; C/N=C(\C)c1cc(N2CCCC2)cc(/C(C)=N/C)n1]

p-Pyrrolidinyl diacetylpyridine was prepared according to literature procedures [(a) De Rycke, N.; Couty, F.; David, O. R. P. Tetrahedron Lett. 2012, 53, 462. (b) Ivchenko, P. V.; Nifant'ev, I. E.; Busboy, I. V. Tetrahedron Lett. 2013, 54, 217]. p-Pyrrolidinyl diacetylpyridine (0.2 g, 0.86 mmol) was weighed into a thick walled glass vessel followed by addition of activated 4A molecular sieves (200 mg). A solution of CH₃NH₂ in EtOH (2 mL, 33 wt %, excess) was injected into the flask. The thick walled glass vessel was immediately sealed and stirred at room temperature for 2 hours. To the resulting mixture was added CH₂Cl₂, followed by filtration. The solid was washed with more CH₂Cl₂. The solvent from the filtrate was removed under vacuum to afford an off-white solid, determined as the desired product in 98% yield. The product is further purified by recrystallization from Et₂O. ¹H NMR (500 MHz, Benzene-d₆) δ 7.77 (s, 2H), 3.39-3.29 (m, 6H), 2.94-2.81 (m, 4H), 2.50-2.38 (m, 6H), 1.30-1.18 (m, 4H). ¹³C NMR (126 MHz, C₆D6) δ 168.83, 156.96, 153.01, 104.78, 47.00, 39.62, 25.10, 13.33.

Synthesis of (^{Me}APDI)Co(CH₂TMS)₂

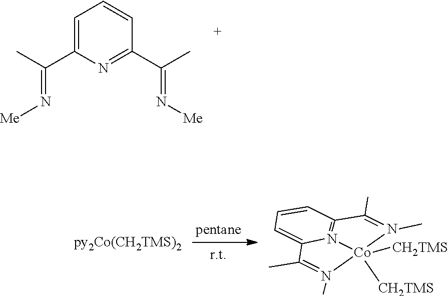

A solution of py₂Co(CH₂TMS)₂ (390 mg, 1 mmol) in pentane (20 mL) was prepared following literature procedures [Zhu, D.; Janssen, F. F. B. J.; Budzelaar, P. H. M. Organometallics 2010, 29, 1897] and cooled to −35° C. The ligand (189 mg, 1 equiv) was dissolved in pentane and added to the solution containing the cobalt precursor. Immediate color change from green to dark brown was observed. The solution was stirred at room temperature for 0.5 hours, followed by removal of the volatiles in vacuo. The residue was dissolved in pentane and filtered through celite. The resulting solution was concentrated and recrystallized at −35° C. to yield a brown solid in 85% yield. ¹H NMR (400 MHz, Benzene-d₆) δ 1.9 (br), −1.30 (br, Co—CH₂SiMe₃).

Synthesis of (^{Et}APDI)Co(CH₂TMS)₂

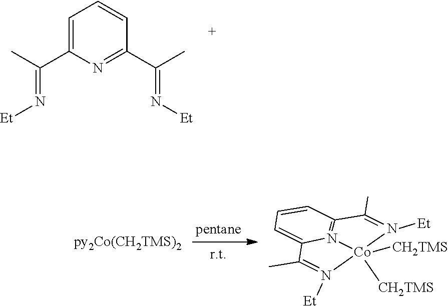

A solution of py₂Co(CH₂TMS)₂ (390 mg, 1 mmol) in pentane (20 mL) was prepared following literature procedures and cooled to −35° C. The ligand (217 mg, 1 equiv) was dissolved in pentane and added to the solution containing the cobalt precursor. Immediate color change from green to dark brown was observed. The solution was stirred at room temperature for 0.5 hours, followed by full evacuation. The residue was dissolved in pentane and filtered through celite. The resulting solution was concentrated and recrystallized at −35° C. to yield a brown solid in 80% yield. ¹H NMR (400 MHz, Benzene-d₆) δ-1.57 (br, Co—CH₂SiMe₃), −9.00 (br, Co—CH₂SiMe₃), −15.4 (br, Co—CH₂SiMe₃).

Synthesis of (^{MeO}APDI)Co(CH₂TMS)₂

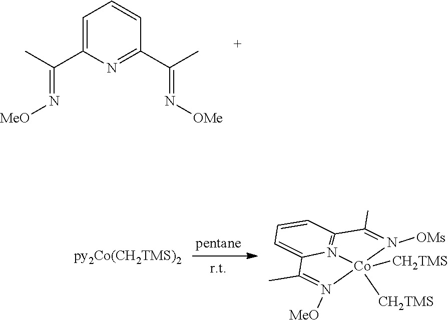

A solution of py₂Co(CH₂TMS)₂ (313 mg, 0.8 mmol) in pentane (10 mL) was prepared following literature procedures and cooled to −35° C. The ligand (177 mg, 1 equiv) was dissolved in pentane and added to the solution containing the cobalt precursor. Immediate color change from green to dark brown was observed. The solution was stirred at room temperature for 0.5 hours, followed by full evacuation. The residue was dissolved in pentane and filtered through celite. The resulting solution was concentrated and recrystallized at −35° C. to yield a brown solid in 60% yield (220 mg). ¹H NMR (400 MHz, Benzene-d₆) δ-0.29 (br, Co—CH₂SiMe₃).

Synthesis of (^{p-pyrrolidinyl,Me}APDI)Co(CH₂TMS)₂

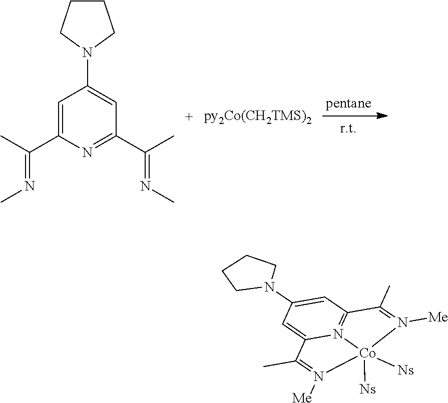

A solution of py₂Co(CH₂TMS)₂ (296 mg, 0.76 mmol) in pentane (10 mL) was prepared following literature procedures and cooled to −35° C. The ligand (195 mg, 0.76 mmol, 1 equiv) was dissolved in pentane and added to the solution containing the cobalt precursor. Immediate color change from green to purple was observed. The solution was stirred at room temperature for 0.5 hours, followed by full evacuation. The residue was dissolved in pentane and filtered through celite. The resulting solution was concentrated and recrystallized at −35° C. to yield a purple solid in 51% yield (280 mg). ¹H NMR (400 MHz, Benzene-d₆) δ-1.08 (br, Co—CH₂SiMe₃), −4.62 (br, Co—CH₂SiMe₃), −11.73 (br, Co—CH₂SiMe₃).

Hydrosilylation/Dehydrogenative Silylation with (PDI)CoNs₂ Complexes

In a glove box, 1-octene (112 mg, 1 mmol) and (EtO)₃SiH (164 mg, 1 mmol) were weighed into a vial equipped with a stir bar. The solid cobalt pre-catalyst (2-3 mg, 0.5 mol %) was weighed into a separate vial, and was subsequently added to the substrates. The vial was sealed with a cap and stirred. After 1 hour, the reaction was quenched by exposure to air. The product mixture was filtered through silica gel and eluted with hexane. The product mixture was directly injected to GC. The residual was filtered through silica gel and eluted with hexane. The resulting solution was dried under vacuum and analyzed by ¹H and ¹³C NMR spectroscopy. The yields are based on conversion of 1-octene. For formation of alkenylsilane C, an equimolar quantity of octane was formed.

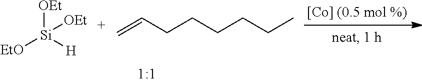

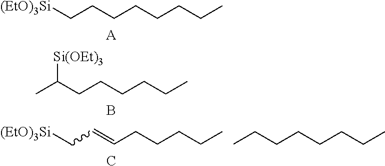

| | Yield (%) | | |
|---|---|---|---|
| | A | B | C |
| 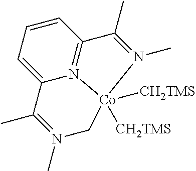 | >98 | 0 | 0 |
| 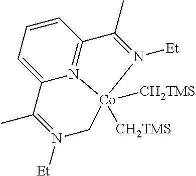 | 15 | 1 | 42 |
| 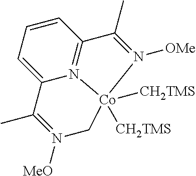 | 3 | 13 | 42 |

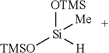

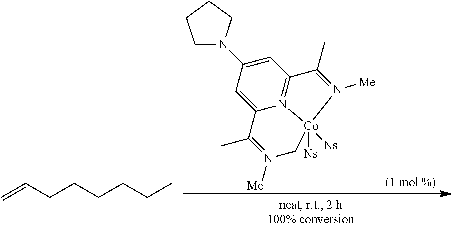

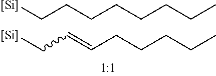

Substrate scope of (^{Me}APDI)CoNs₂ Catalyzed Hydrosilylation

In a glove box, substrates (1 mmol) were weighed into a vial equipped with a stir bar. Solid (^{Me}APDI)CoNs₂ (2 mg, 0.5 mol %) was weighed into a separate vial, and was subsequently added to the mixture of substrates. The vial was sealed with a cap and stirred at room temperature. After the desired amount of time, the reaction was quenched by exposure to air. The product mixture was diluted with hexane and injected to GC. The product mixture was filtered through silica gel and eluted with hexane. The resulting solution was dried under vacuum and analyzed by ¹H and ¹³C NMR spectroscopy.

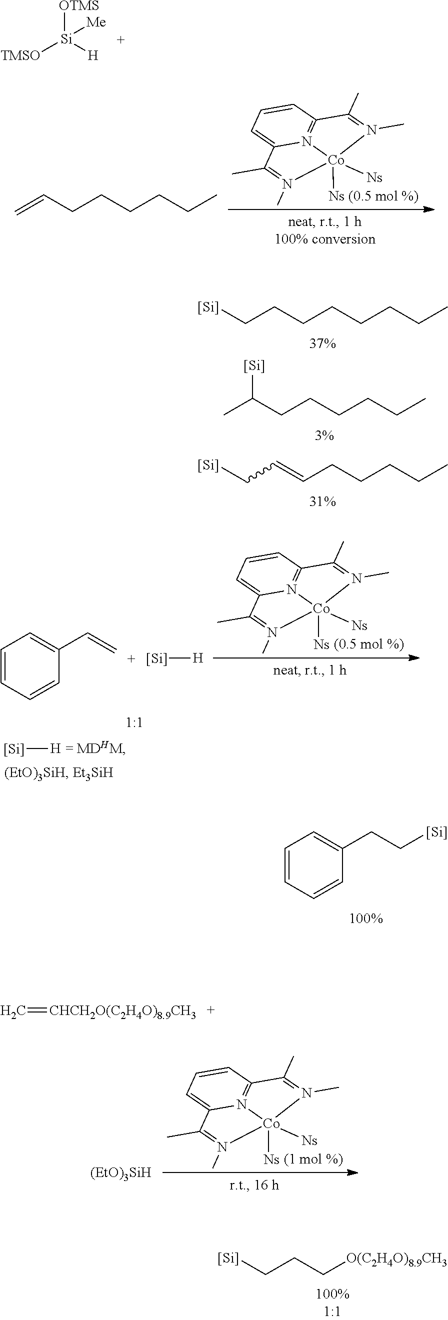

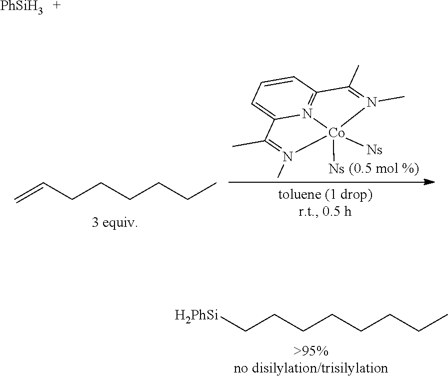

Cross-Linking Siloxanes Using the ^{Me}APDICoNs₂ Catalyst

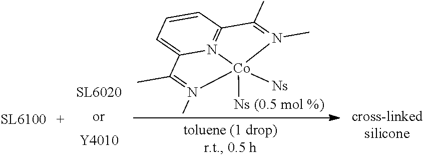

In a glove box, a scintillation vial was charged with 1.0 g of M^{Vi} D₁₂₀M^{Vi} (SL6100) and 0.044 g of MD₁₅D^{H}₃₀M (SL6020 D1). In a second vial, a solution of the catalyst was prepared by dissolving 2 mg of (^{Me}APDI)CoNs₂ in 0.1 mL of toluene. The catalyst solution was added to the stirring solution of the substrate mixture while stirring. The vial was sealed with a cap and stirred for 0.5 h, after which gel formation was observed. Exposure of the reaction to air resulted in a colorless gel.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A process for producing a crosslinked material, the process comprising reacting a mixture of (a) a silylhydride containing polymer; (b) a mono-unsaturated olefin, an unsaturated polyolefin, or a combination of two or more thereof; and (c) a catalyst, wherein the catalyst is a complex of the Formula (I) or an adduct thereof: 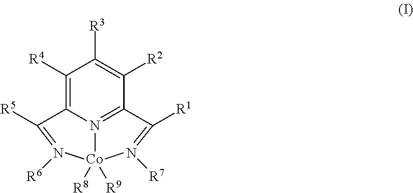
wherein each occurrence of R¹, R², and R⁵ is independently hydrogen, C1-C18 alkyl, a C1-C18 substituted alkyl, an aryl, a substituted aryl, or an inert substituent, wherein one or more of R¹—R⁵, other than hydrogen, optionally contain at least one heteroatom; each occurrence of R⁶ and R⁷ is independently a C1-C18 alkyl or C1-C18 substituted alkyl, or alkoxy, wherein one or both of R⁶ and R⁷ optionally contain at least one heteroatom; optionally any two of R¹—R⁷ vicinal to one another, R¹—R², and/or R⁴—R⁵ taken together may form a ring being a substituted or unsubstituted, saturated, or unsaturated cyclic structure, with the proviso that R¹—R⁷ and R⁵—R⁶ are not taken to form a terpyridine ring; and, R⁸ and R⁹ are independently chosen from a C1-C18 alkyl group, or a C1-C18 substituted alkyl group, and R⁸ and R⁹ optionally contain one or more heteroatoms that may contain aryl substituents.

2. A process for the hydrosilylation of a composition comprising hydrosilylation reactants chosen from (a) an unsaturated compound containing at least one unsaturated functional group, and (b) a silyl hydride and/or siloxyhydride containing at least one SiH functional group, the process comprising contacting the composition comprising the hydrosilylation reactants wherein the catalyst is a complex of the Formula (I) or an adduct thereof: 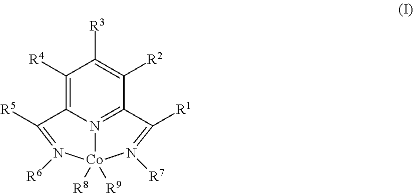
wherein each occurrence of R¹, R², and R⁵ is independently hydrogen, C1-C18 alkyl, a C1-C18 substituted alkyl, an aryl, a substituted aryl, or an inert substituent, wherein one or more of R¹—R⁵, other than hydrogen, optionally contain at least one heteroatom; each occurrence of R⁶ and R⁷ is independently a C1-C18 alkyl, a C1-C18 substituted alkyl, and/or an alkoxy, wherein one or both of R⁶ and R⁷ optionally contain at least one heteroatom; optionally any two of R¹—R⁷ vicinal to one another, R¹—R², and/or R⁴—R⁵ taken together may form a ring being a substituted or unsubstituted, saturated, or unsaturated cyclic structure, with the proviso that R¹—R⁷ and R⁵—R⁶ are not taken to form a terpyridine ring; and R⁸ and R⁹ are independently chosen from a C1-C18 alkyl, or a C1-C18 substituted alkyl, and R⁸ and R⁹ optionally contain one or more heteroatoms that may contain aryl substituents.

3. The process of claim 2, wherein R⁶ and R⁷ are independently chosen from methyl and ethyl.

4. The process of claim 2, wherein R¹ and R⁵ are independently chosen from methyl and phenyl.

5. The process of claim 2, wherein R², R³, and R⁴ are hydrogen.

6. The process of claim 2, wherein at least one of R², R³, and R⁴ comprises a pyrrolidinyl group.

7. The process of claim 2, wherein the catalyst is chosen from a complex of Formulas (III)-(VI): 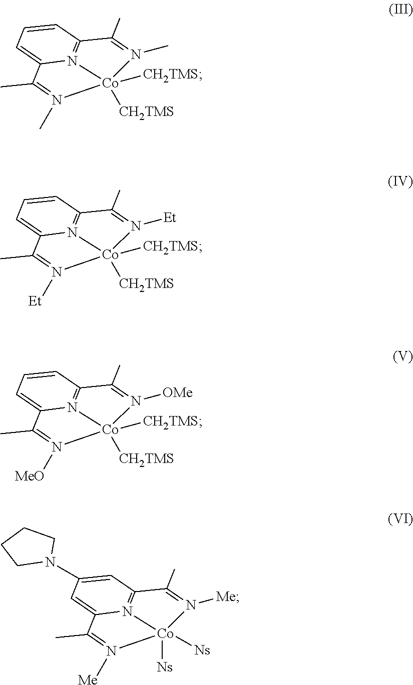
or a combination of two or more thereof.

8. The process of claim 2, wherein the catalyst is of the Formula (III), and the resulting products are essentially free of any dehydrogenative silylated product.

9. The process of claim 2, wherein the resulting product comprises a mixture of hydrosilylated product and dehydrogenative silylated product.

10. The process of claim 2, wherein the silyl/siloxy hydride is chosen from one or a combination of compounds of the formulas:
R¹⁰ₘSiHₚX₄₋₍ₘ₊ₚ₎; and
MₐM^{H}_{b}D_{c}D^{H}_{d}TₑT^{H}_{f}Q_{g},
where each R¹⁰ is independently a substituted or unsubstituted aliphatic or aromatic hydrocarbyl group; X is halogen, alkoxy, acyloxy, or silazane; m is 1-3; p is 1-3; M represents a monofunctional group of formula R¹¹₃SiO_{1/2}; a D represents a difunctional group of formula R¹²SiO_{2/2}; a T represents a trifunctional group of formula R¹³SiO_{3/2}; Q represents a tetrafunctional group of formula SiO_{4/2}; M^{H} represents HR¹⁴₂SiO_{1/2}, T^{H} represents HSiO_{3/2}, and D^{H} group represents R¹⁵HSiO_{2/2}; each occurrence of R¹⁰⁻¹⁵ is independently a C₁-C₁₈ alkyl, a C₁-C18 substituted alkyl, a C₆-C₁₄ aryl or substituted aryl, wherein R¹⁰⁻¹⁵ optionally and independently contains at least one heteroatom; subscripts a, b, c, d, e, f, and g are such that the molar mass of the compound is between 100 and 100,000 Dalton.

11. The process of claim 2, wherein the siloxy hydride compound comprises a carbosiloxyhydride comprising carbosiloxane linkages.

12. The process of claim 11, wherein the carbosiloxyhydride is of the formula RⁱRⁱⁱRⁱⁱⁱSi(CH₂R^{iv})ₓSiOSiR^{v}R^{vi}(OSiR^{vii}R^{viii})_{y}OSiR^{ix}R^{x}H, wherein Rⁱ—R^{x} is independently a monovalent alkyl, cycloalkyl or aryl group such as methyl, ethyl, cyclohexyl or phenyl, with the proviso that Rⁱ can independently be H, the subscript x has a value of 1-8, y has a value from zero to 10 and is preferably zero to 4.

13. The process of claim 2, wherein the unsaturated compound (a) is chosen from an unsaturated polyether; a vinyl functionalized alkyl capped allyl or methylallyl polyether; a terminally unsaturated amine; an alkyne; a C2-C45 olefins; an unsaturated epoxide; a terminally unsaturated acrylate or methyl acrylate; an unsaturated aryl ether; an unsaturated aromatic hydrocarbon; unsaturated cycloalkane; a vinyl-functionalized polymer or oligomer; a vinyl-functionalized silane, a vinyl-functionalized silicone, terminally unsaturated alkenyl-functionalized silane and/or silicone; unsaturated fatty acids; unsaturated fatty esters;
vinyl-functional synthetic or natural minerals, or a combination of two or more thereof.

14. The process according to claim 13, wherein the unsaturated compound (a) is chosen from one or more polyethers having the general formula:
R¹⁶(OCH₂CH₂)_{z}(OCH₂CHR¹⁷)_{w}—OR¹⁸; and/or
R¹⁶O(CHR¹⁷CH₂O)_{w}(CH₂CH₂O)_{z}—CR¹⁹₂—C≡C—CR¹⁹₂(OCH₂CH₂)_{z}(OCH₂CHR¹⁷)_{w}OR¹⁸
wherein R¹⁶ is chosen from an unsaturated organic group having from 2 to 10 carbon atoms; R¹⁸ is independently chosen from a hydrogen, vinyl, allyl, methallyl, or a polyether capping group of from 1 to 8 carbon atoms, an acyl group, a beta-ketoester group, or a trialkylsilyl group; R¹⁷ and R¹⁹ are independently chosen from hydrogen, a monovalent hydrocarbon group, an aryl group, an alkaryl group, and a cycloalkyl group; each occurrence of z is 0 to 100 inclusive; and each occurrence of w is 0 to 100 inclusive.

15. The process of claim 2 further comprising removal of the catalyst composition.

16. The process of claim 15, wherein removal of the catalyst composition is achieved by filtration.

17. The process of claim 2, wherein the reaction is conducted at a temperature of from about −10° C. to about 300° C.

18. The process of claim 2, wherein the reaction is conducted in a subatmospheric pressure.

19. The process of claim 2, wherein the reaction is conducted in a supra-atmospheric pressure.

20. The process of claim 2, wherein the catalyst is present in an amount of from about 0.01 mole percent to about 10 mole percent based on the quantity of the unsaturated compound.

21. The process of claim 2, wherein the complex is immobilized on a support.

22. The process of claim 21, wherein the support is chosen from carbon, silica, alumina, MgCl₂, zirconia, polyethylene, polypropylene, polystyrene, poly(aminostyrene), sulfonated polystyrene, or a combination of two or more thereof.
